(19) United States
(12) Patent Application Publication
(10) Pub. No.: US 2023/0369564 A1
(43) Pub. Date: Nov. 16, 2023

(54) ELECTRODE MIXTURE USED FOR AN ALL-SOLID-STATE SODIUM STORAGE BATTERY, AND A STORAGE BATTERY COMPRISING THE SAME

(71) Applicants: NATIONAL INSTITUTE OF ADVANCED INDUSTRIAL SCIENCE AND TECHNOLOGY, Chiyoda-ku, Tokyo (JP); Nippon Electric Glass Co., Ltd., Shiga (JP)

(72) Inventors: Taichi SAKAMOTO, Osaka (JP); Yuta IKEUCHI, Osaka (JP); Takashi MUKAI, Osaka (JP); Hiroshi SENOH, Osaka (JP); Hideaki TANAKA, Osaka (JP); Masahiro YANAGIDA, Osaka (JP); Hideo YAMAUCHI, I, Shiga (JP); Junichi IKEJIRI, Shiga (JP); Kei TSUNODA, Shiga (JP); Ayumu TANAKA, Shiga (JP); Fumio SATO, Shiga (JP)

(21) Appl. No.: 18/029,231

(22) PCT Filed: Sep. 3, 2021
(86) PCT No.: PCT/JP2021/032515

§ 371 Date: Mar. 29, 2023

(30) Foreign Application Priority Data
Sep. 30, 2020 (JP) 2020-166581

(51) Int. Cl. H01M 4/36; H01M 4/62; H01M 4/58

(52) U.S. Cl. CPC H01M 4/364; H01M 4/625; H01M 4/626; H01M 4/5825; H01M 2004/021

(57) ABSTRACT

Provided is an electrode mixture used for an all-solid-state sodium storage battery that can maintain a high discharging capacity in a room temperature environment and exhibit excellent charge-discharge cycle characteristics. Further provided is a storage battery comprising the same. An object of the present invention is to provide an electrode mixture used for an all-solid-state sodium storage battery, the electrode mixture comprising an active material, wherein the active material is a cluster formed of polyphosphate acid transition metal oxide with a plurality of individual particles connected together, each particle having a particle size within the range of 0.1 μm to 100 μm.

### BACKGROUND OF THE INVENTION

### Field of the Invention

The present invention relates to an electrode mixture used for an all-solid-state sodium storage battery, and a storage battery comprising the same.

### Description of Related Art

The application field of high energy density storage batteries (secondary batteries) has been expanding, which ranges from batteries for mobile devices such as smart phones and tablet devices to, in recent years, batteries for electric vehicles and energy storage systems. In particular, the automobile manufacturing industry has actively advanced the development and the commercialization of clean vehicles (such as electric vehicles and plug-in hybrid vehicles) in order to align with environmental regulations for the purpose of reducing vehicle emission and carbon dioxide (CO₂) emission on a world-wide basis.

In addition, the renewable energy industry, such as wind energy and solar energy, requires large storage battery systems since the energy generation level may be varied greatly due to environmental effects. In recent years, the energy generation cost for renewable energy is less than half of that of coal-fired power, which results in the expansion of the power generation share. In light of its widespread use in the future, there is a need for an improvement in the battery production capacity.

Storage batteries are positioned as essential devices for energy saving and introduction of new energy or clean vehicles, and critical devices in terms of economic growth in various countries.

Currently existing storage batteries, including lithium ion batteries, have driven various industries such as the electronics and automobile industries, but, depending on their use, their full-scale, widespread use has been slowed by their insufficiencies in the temperature characteristics and safety assurance, and the like. Thus, there is a demand for the development of new batteries that are suitable for each use while ensuring both high performance and high safety of the batteries. In addition, for rare metals and other resources from unevenly distributed production areas, risk management is important in light of erratic fluctuations in market prices, limited availabilities and the like. Although the development of technologies for recycling rare metals is ongoing from various aspects, there is still a demand for the development of batteries composed of cheap and easily available materials that are not from unevenly distributed production areas (Mukai Takashi: In-Vehicle Technology, 5(4), 19-24 (2018); and Mukai Takashi: Lithium-Ion Battery: Development of Performance Improvement and Trends in the Vehicle LIB Industry, Part 1, Chapter 6, Science & Technology, pp. 91-94 (2019)).

Currently, the development of sodium ion batteries and all-solid-state batteries is ongoing as cell systems capable of solving these problems.

Sodium is abundant in seawater and the sixth most common element in the Earth's crust, and thus, it is inexpensive and easily available, with production areas not being unevenly distributed, unlike those of lithium. Therefore, the resource supply risk can be mitigated, and cost reduction is expected to be achieved for such batteries.

This element is very appealing in view of the recent trend of rare metal free, but the oxidation reduction potential is 0.3V higher, the ion volume is twice or more, and the atomic weight is about 3.3 times, as compared to those of lithium. Sufficient electric capacity and cycle characteristics are less likely to be obtained by merely replacing ion species of a conventional lithium ion battery with sodium ions.

Among cell systems comprising sodium, there are sodium-sulfur batteries and sodium-metal chloride batteries, in addition to the above. Sodium-sulfur batteries are composed of aluminum oxide containing sodium, such as β-alumina or β″-alumina, as a solid electrolyte; sodium as a negative electrode active material; and sulfur as a positive electrode active material.

Sodium-metal chloride batteries comprise the same solid electrolyte and the same negative electrode active material, but they comprise metal chloride such as NaAlCl₄, NiCl₂, FeCl₂, CoCl₂, CrCl₂ or the like as a positive electrode active material.

Sodium-sulfur batteries and sodium-metal chloride batteries do not require an electrolytic solvent, but, unlike lithium ion batteries and sodium ion batteries, they cannot operate at room temperature. Therefore, such batteries are maintained at a temperature between 250 and 350° C. by an external heat source or the like to bring the negative electrode active material and the positive electrode active material to a molten state, which allows an improvement in the ion conductivity of the solid electrolyte.

In contrast, all-solid-state batteries are cell systems comprising a solid electrolyte. Since this solid electrolyte conducts ions between the positive electrode and the negative electrode, such batteries can be produced without any organic solvent that is required for sodium ion batteries (sodium storage batteries comprising an electrolyte solution). For example, sodium ion batteries generally comprise sodium hexafluorophosphate (NaPF₆) salt as an electrolyte solution, but due to the mobility of hexafluorophosphate ions (PF₆⁻) as well as the mobility of sodium ions (NO during charging and discharging of the batteries, there have been difficulties in making the sodium ion transference number be one.

However, in an inorganic system solid electrolyte, there is no concentration polarization, and thus, the sodium ion transference number is close to one. If an electrolyte with a suitable potential window is selected, side reactions such as dissolution reaction of the active material, gas generation by the electrolysis, and deposition of the decomposition product of the electrolyte solution can be suppressed. In addition, storage batteries comprising such electrolyte are expected to have excellent safety and reliability since there is less likelihood of ignition and leakage of gas or liquid.

There is a need for an all-solid-state sodium storage battery composed of a positive electrode, a negative electrode and an electrolyte, like conventional storage batteries, except the electrolyte is solid and has sodium ion conductivity.

The positive electrode and the negative electrode are composed of an active material capable of absorbing and alloying with sodium ions during charging and discharging, and a solid electrolyte. For example, known as active materials used for the positive electrode are TiS₂ (e.g., G. H. Newman, L. P. Klemann: J. Electrochem. Soc. 127, 2097-2099 (1980)), NaMO₂ (M=Co, Ni, Mn, Fe) (e.g., J.-J. Braconnier, C. Delmas, C. Fouassier, P. Hagenmuller: Mat. Res. Bull., 15, 1797-1804 (1980); S. Okada, Y. Takahashi, T. Kiyabu, T. Doi, J. Yamaki, T. Nishida: ECS Meeting Abstr., 602, 201 (2006); and N. Yabuuchi, M. Kajiyama, J. Iwatate, H. Nishikawa, S. Hitomi, R. Okuyama, R. Usui, Y. Yamada, S. Komaba: Nat. Mater., 11, 512-517 (2012)), Na₂MnO₃-NaMO₂ (e.g., Japanese Unexamined Patent Application Publication No. 2014-229452), NaMP₂O₇ (e.g., Japanese Unexamined Patent Application Publication No. 2018-32536) and the like. Known as active materials used for the negative electrode are hard carbon (e.g., International Publication WO2010/109889), soft carbon (e.g., Japanese Unexamined Patent Application Publication No. 2013-171798), individual elements and compounds including tin and antimony (e.g., International Publication WO2013/065787; and Japanese Unexamined Patent Application Publication No. 2015-28922), sodium metal and the like.

As a result of vigorous research and development, various solid electrolytes exhibiting a high ion conductivity have been found to date (e.g., Japanese Unexamined Patent Application Publication No. 2010-15782; Japanese Unexamined Patent Application Publication No. 2017-37769; Japanese Unexamined Patent Application Publication No. 2019-57495; and Japanese Unexamined Patent Application Publication No. 2019-57496). Most of these electrolytes are non-crystalline solids or crystalline solids composed of sodium salts and inorganic derivatives.

However, since these electrolytes are powder or sheet materials and most of them have a high reactivity with water, conventional battery production methods cannot be applied as they are. Specifically, there are difficulties in infiltrating the electrode active material layer with the electrolyte to build ion conduction paths in all-solid-state sodium storage batteries, unlike in liquid sodium ion batteries. Therefore, there is a need for boosting the ion conductivity between solid particles of the solid electrolyte and the active material by containing the solid electrolyte in the active material layer.

For example, Japanese Unexamined Patent Application Publication No. 2018-18578; Japanese Unexamined Patent Application Publication No. 2016-42453; and H. Yamauchi, J. Ikejiri, F. Sato, H. Oshita, T. Honma, T. Komatsu: J. Am. Ceram. Soc., 102 (11), 6658-6667 (2019), propose an electrode mixture (active material layer) comprising an active material and a solid electrolyte or an all-solid-state sodium storage battery comprising the same, obtained by preparing an electrode mixture precursor (active material layer precursor) containing active material precursor powder and solid electrolyte powder and firing it. For example, Na₂FeP₂O₇ crystallized glass is used as the active material precursor. Glasses and crystallized glasses are crystallized upon firing (heat treatment), which causes softening and fluidization during this process. Therefore, the active material precursor powder can be integrated with the solid electrolyte powder by merely firing them, without applying any pressure.

In addition, according to Japanese Unexamined Patent Application Publication No. 2018-18578; Japanese Unexamined Patent Application Publication No. 2016-42453; and H. Yamauchi, J. Ikejiri, F. Sato, H. Oshita, T. Honma, T. Komatsu: J. Am. Ceram. Soc., 102 (11), 6658-6667 (2019), the electrode mixture is formed on one surface of the solid electrolyte layer by applying the foregoing electrode mixture precursor on the surface of the solid electrolyte layer and firing it at 400° C. or above.

However, since the solid electrolyte does not have electron conductivity, there are difficulties in ensuring both electron conductivity and ion conductivity of the electrode. In order to overcome this, it is easy to conceive of containing an electron conductive assistant therein. However, if the content of the electron conductive assistant becomes too large, the content of the active material per unit mass of the electrode mixture becomes small, which tends to cause a decrease in charging-discharging capacity. In addition, this causes obstructions to sintering, which causes destruction of ion conduction paths, suggesting a decrease in charging-discharging capacity as well as discharge voltage.

### BRIEF SUMMARY OF THE INVENTION

### Problems to be Solved by the Invention

As mentioned above, for achieving high performance of the all-solid-state sodium storage battery, it is important to find the technology to enhance the ion conductivity between the solid particles of the solid electrolyte and the active material while maintaining the electron conductivity of the electrode.

As described in Japanese Unexamined Patent Application Publication No. 2018-18578; Japanese Unexamined Patent Application Publication No. 2016-42453; and H. Yamauchi, J. Ikejiri, F. Sato, H. Oshita, T. Honma, T. Komatsu: J. Am. Ceram. Soc., 102 (11), 6658-6667 (2019), the inventors focused on the technology to integrate the active material and the solid electrolyte by press-molding an electrode mixture precursor (electrode active material layer precursor) consisting of active material precursor powder and solid electrolyte powder, or alternatively further adding a solvent to form it into slurry (paste), and then firing it.

In order to attain high performance of the battery, that is, high capacity of the positive electrode formed per unit area of the surface of the solid electrolyte layer, it is necessary to increase the application amount of the electrode mixture formed per unit area of the surface of the solid electrolyte layer for achieving high loading of the electrode active material. However, as described in Japanese Unexamined Patent Application Publication No. 2018-18578 and Japanese Unexamined Patent Application Publication No. 2016-42453, when the mixture consisting of the active material precursor and the solid electrolyte is applied thickly on the surface of the electrolyte and fired for achieving high loading, only the electrode mixture layer sinters and contracts, which causes a problem that the electrode mixture layer will be separated from the electrolyte and the function of the battery will not be achieved.

In addition, when the mixture consisting of the active material precursor and the solid electrolyte is fired, the active material precursor powder and the solid electrolyte powder react with each other at the interface between the active material and the solid electrolyte, which may result in generating a heterogeneous crystalline phase. Since this heterogeneous crystalline phase does not function as a practical active material and has inferior ion conductivity as compared to the solid electrolyte layer, it has been found to be a factor that decreases the battery performance.

As mentioned above, the inventors initially examined to attain high performance of an all-solid-state sodium storage battery by forming the electrode mixture directly on the surface of the inorganic solid electrolyte, but when the electrode is formed directly on the surface of the inorganic solid electrolyte and integrated, the battery has a high resistance and a limited high capacity per unit area with the currently existing technology. Therefore, the inventors have studied to use the electrode mixture and the inorganic solid electrolyte as separate materials, instead of forming the electrode mixture directly on the surface of the inorganic solid electrolyte, to form a battery, and they have made the present invention. The invention can solve conventional problems as mentioned above as well as issues newly found by the inventors.

In order to achieve the objects as mentioned above, the inventors have conducted extensive search on configurations of the electrode mixture used for an all-solid-state sodium storage battery with sodium ions serving as carriers, and repeated trial and error and intensive research on the combination of materials and effects obtained therefrom, which resulted in the successful development of the electrode mixture to obtain an all-solid-state sodium storage battery with sodium ions serving as carriers at a practical level.

### Means for Solving the Problems

The invention according to a first aspect is an electrode mixture used for an all-solid-state sodium storage battery, the electrode mixture comprising an active material, wherein the active material is a cluster formed of polyphosphate acid transition metal oxide with a plurality of individual particles connected together, each particle having a particle size ranging from 0.1 μm to 100 μm.

The invention according to a second aspect is the electrode mixture of the first aspect, wherein the polyphosphate acid transition metal oxide is crystal represented by the general formula NaₐM_{b}P_{c}O_{d}, and wherein M is at least any one selected from Fe, Mn, Co, Ni and V (provided that 0.0<a≤3.5, b=1, 1.0≤c≤3.0, and 3.0≤d≤30).

The invention according to a third aspect is the electrode mixture of the first or second aspect, further comprising an ion conductive assistant, wherein the ion conductive assistant is at least one selected from a group consisting of ethylene carbonate (EC), polyethylene carbonate (PEC), polyethylene glycol (PEG), and polyethylene oxide (PEO).

The invention according to a fourth aspect is the electrode mixture of any one of the first to third aspects, further comprising an electron conductive assistant, wherein the electron conductive assistant is at least one selected from a group consisting of metal, carbon material, conductive polymer, and conductive glass.

The invention according to a fifth aspect is the electrode mixture of any one of the first to fourth aspects, wherein the electron conductive assistant is loaded on part or all of a surface of the electrode mixture.

The invention according to a sixth aspect is the electrode mixture of any one of the first to fifth aspects, wherein the electron conductive assistant is loaded on a surface of a part of the ion conductive assistant that connects the individual particles of the active material.

The invention according to a seventh aspect is the electrode mixture of any one of the first to sixth aspects, wherein the electron conductive assistant is contained within a part of the ion conductive assistant that connects the individual particles of the active material.

The invention according to an eighth aspect is the electrode mixture of any one of the fourth to seventh aspects, wherein the electron conductive assistant is carbon selected from at least one of powdered carbon, fibrous carbon, and flaky carbon.

The invention according to a ninth aspect is the electrode mixture of the eighth aspect, wherein the carbon is powdered carbon having a primary particle size within the range of 1 nm to 100 nm.

The invention according to a tenth aspect is the electrode mixture of the eighth or ninth aspect, wherein the carbon is powdered carbon having a nitrogen adsorption specific surface area within the range of 20 m²/g to 500 m²/g.

The invention according to an eleventh aspect is the electrode mixture of the eighth aspect, wherein the carbon is fibrous carbon having a fiber size within the range of 1 nm to 300 nm.

The invention according to a twelfth aspect is the electrode mixture of the eighth aspect, wherein the carbon is flaky carbon further having a thickness within the range of 1 nm to 300 nm.

The invention according to a thirteenth aspect is the electrode mixture of any one of the eighth to twelfth aspects, wherein the carbon is a combination of powdered carbon and fibrous carbon, or a combination of powdered carbon and flaky carbon, or a combination of powdered carbon, fibrous carbon and flaky carbon.

The invention according to a fourteenth aspect is the electrode mixture of any one of the first to thirteenth aspects, wherein the electrode mixture does not comprise a resin binder.

The invention according to a fifteenth aspect is the electrode mixture of any one of the first to fourteenth aspects, wherein the electrode mixture is further porous comprising pores, and wherein the electrode mixture has a porosity within the range of 5% to 50%.

The invention according to a sixteenth aspect is the electrode mixture of the fifteenth aspect, wherein the pores have a pore size of 0.1 μm to 100 μm.

The invention according to a seventeenth aspect is the electrode mixture of any one of the first to sixteenth aspects, comprising solid electrolyte powder having a particle size of 0.1 μm to 100 μm as an ion conductive assistant.

The invention according to an eighteenth aspect is the electrode mixture of any one of the fifteenth to seventeenth aspects, wherein surfaces of the pores are covered with the solid electrolyte powder as an ion conductive assistant.

The invention according to a nineteenth aspect is the electrode mixture of any one of the first to eighteenth aspects, wherein the electrode mixture has a thickness of 10 μm to 5000 μm and a total weight per unit area of 1 mg/cm² to 5000 mg/cm².

The invention according to a twentieth aspect is the electrode mixture of any one of the first to nineteenth aspects, wherein the electrode mixture is used as a positive electrode and/or a negative electrode in a non-aqueous electrolyte storage device, and wherein the non-aqueous electrolyte storage device is an all-solid-state sodium storage battery comprising the electrode mixture, an organic solid electrolyte, an inorganic solid electrolyte, and a current collector.

The invention according to a twenty-first aspect is the electrode mixture of the twentieth aspect, wherein the electrode mixture is used in an assembled battery comprising an all-solid-state sodium storage battery as a non-aqueous electrolyte storage device.

The invention according to a twenty-second aspect is the electrode mixture of the twentieth or twenty-first aspect, wherein the electrode mixture is used in an electrical apparatus equipped with an all-solid-state sodium storage battery as a non-aqueous electrolyte storage device or an assembled battery thereof.

### Effects of the Invention

The invention according to the first aspect is an electrode mixture used for an all-solid-state sodium storage battery, the electrode mixture comprising an active material, wherein the active material is a cluster formed of polyphosphate acid transition metal oxide with a plurality of individual particles connected together, each particle having a particle size ranging from 0.1 μm to 100 μm, which can boost the ion conductivity as well as the output characteristics, and thus maintain a high discharging capacity in a room temperature environment. This electrode mixture further exhibits excellent charge-discharge cycle characteristics and has the ability to shut down when the battery is overcharged. If the particle size is less than 0.1 μm, the handling becomes difficult. If the particle size is over 100 μm, the porosity increases and the output characteristics deteriorate.

The invention according to the second aspect is the electrode mixture, wherein the polyphosphate acid transition metal oxide is crystal represented by the general formula NaₐM_{b}P_{c}O_{d}, and wherein M is at least any one selected from Fe, Mn, Co, Ni and V (provided that 0.0<a≤3.5, b=1, 1.0≤c≤3.0, and 3.0≤d≤30), which can boost the ion conductivity, charging-discharging capacity, or output characteristics.

The invention according to the third aspect is the electrode mixture further comprising an ion conductive assistant, wherein the ion conductive assistant is at least one selected from a group consisting of ethylene carbonate (EC), polyethylene carbonate (PEC), polyethylene glycol (PEG), and polyethylene oxide (PEO), which enables a reduction in ionic resistance of the electrode mixture as well as oxidative decomposition of the material selected from EC, PEC, PEG, and PEO contained in the electrode mixture, when the battery is overcharged, thereby functioning to suppress the battery voltage increase.

The invention according to the fourth aspect is the electrode mixture further comprising an electron conductive assistant, wherein the electron conductive assistant is at least one selected from a group consisting of metal, carbon material, conductive polymer, and conductive glass, which enables an increase in electron conductivity.

The invention according to the fifth aspect is the electrode mixture, wherein the electron conductive assistant is loaded on part or all of a surface of the electrode mixture, which enables an increase in electron conductivity.

The invention according to the sixth aspect is the electrode mixture, wherein the electron conductive assistant is loaded on a surface of a part that connects the individual particles of the active material, which enables an improvement in electron conductivity between the particles of the active material.

The invention according to the seventh aspect is the electrode mixture, wherein the electron conductive assistant is contained within a part that connects the individual particles of the active material, which leads to an improvement in electron conductivity between the particles of the active material.

The invention according to the eighth aspect is the electrode mixture, wherein the electron conductive assistant is carbon selected from at least one of powdered carbon, fibrous carbon, and flaky carbon, which enables the achievement of a higher electron conductivity and a lower specific gravity.

The invention according to the ninth aspect is the electrode mixture, wherein the carbon is powdered carbon having a primary particle size within the range of 1 nm to 100 nm, and the carbon serving as the electron conductive assistant enables an improvement in electron conductivity between the particles of the active material, and thus a significant improvement in output characteristics of the battery.

The invention according to the tenth aspect is the electrode mixture, wherein the carbon is powdered carbon having a nitrogen adsorption specific surface area within the range of 20 m²/g to 500 m²/g, which enables an improvement in electron conductivity of the electrode mixture since the carbon serving as the electron conductive assistant exists at the connections between particles of the active material, and thus a significant improvement in output characteristics of the battery.

The invention according to the eleventh aspect is the electrode mixture, wherein the carbon is fibrous carbon having a fiber size within the range of 1 nm to 300 nm, which leads to less likelihood of the conductive network being broken when the electrode mixture undergoes a change in volume during charging and discharging, and thus an improvement in cycle life characteristics of the battery.

The invention according to the twelfth aspect is the electrode mixture, wherein the carbon is flaky carbon further having a thickness within the range of 1 nm to 300 nm, which leads to less likelihood of the conductive network being broken when the electrode mixture undergoes a change in volume during charging and discharging, and thus an improvement in cycle life characteristics of the battery.

The invention according to the thirteenth aspect is the electrode mixture, wherein the carbon is a combination of powdered carbon and fibrous carbon, or a combination of powdered carbon and flaky carbon, or a combination of powdered carbon, fibrous carbon and flaky carbon, which leads to less likelihood of the conductive network being broken when the electrode mixture undergoes a change in volume during charging and discharging, and thus an improvement in cycle life characteristics of the battery.

The invention according to the fourteenth aspect is the electrode mixture, wherein the electrode mixture does not comprise a resin binder, which no longer leads to an increase in electronic resistance nor ion resistance, and, if the electrode mixture is produced upon firing the active material precursor, no longer leads to loss of binding function as a binder due to pyrolysis nor does it lead to a decrease in performance of the active material or the solid electrolyte due to moisture vapor generated at the time of pyrolysis.

The invention according to the fifteenth aspect is the electrode mixture, wherein the electrode mixture is further porous comprising pores, and the electrode mixture has a porosity within the range of 5% to 50%, which ensures sufficient containment of EC, PEC, PEG, or PEO in the electrode mixture, and thus leads to an increase in ratio of the active material in the electrode mixture as well as an increase in energy density.

The invention according to the sixteenth aspect is the electrode mixture, wherein the pores have a pore size of 0.1 μm to 100 μm, which allows easy infiltration of EC, PEC, PEG, PEO or the like into the electrode mixture, resulting in an increase in strength as well as less likelihood of the electrode mixture being damaged.

The invention according to the seventeenth aspect is the electrode mixture, wherein the electrode mixture comprises solid electrolyte powder having a particle size of 0.1 μm to 100 μm as an ion conductive assistant, which enables the achievement of a sufficient ion conductivity.

The invention according to the eighteenth aspect is the electrode mixture, wherein surfaces of the pores are covered with the solid electrolyte powder as an ion conductive assistant, which enables the achievement of a sufficient electron conductivity.

The invention according to the nineteenth aspect is the electrode mixture, wherein the electrode mixture has a thickness of 10 μm to 5000 μm and a total weight per unit area of 1 mg/cm′ to 5000 mg/cm′, which enables the achievement of a sufficient charging-discharging capacity.

The invention according to the twentieth aspect is the electrode mixture, wherein the electrode mixture is used as a positive electrode and/or a negative electrode in a non-aqueous electrolyte storage device, and the non-aqueous electrolyte storage device is an all-solid-state sodium storage battery comprising the electrode mixture, an organic solid electrolyte, an inorganic solid electrolyte, and a current collector, which enables the achievement of a high voltage and therefore the achievement of a high-performance all-solid-state sodium storage battery.

The invention according to the twenty-first aspect is the electrode mixture, wherein the electrode mixture is used in an assembled battery comprising an all-solid-state sodium storage battery as a non-aqueous electrolyte storage device, which enables the achievement of a high voltage and therefore the achievement of a high-performance assembled battery.

The invention according to the twenty-second aspect is the electrode mixture, the electrode mixture is used in an electrical apparatus equipped with an all-solid-state sodium storage battery as a non-aqueous electrolyte storage device or an assembled battery thereof, which enables the achievement of an electrical apparatus that is easy to use and efficient in operation.

### BRIEF DESCRIPTION OF DRAWINGS

FIG. 1 is a schematic cross-sectional view of an active material cluster contained in an electrode mixture according to the present invention.

FIG. 2 is a schematic cross-sectional view of an active material cluster contained in an electrode mixture according to the present invention.

FIG. 3 is a schematic cross-sectional view of an all-solid-state sodium storage battery produced with an electrode mixture according to the present invention.

FIG. 4 is a schematic cross-sectional view of an all-solid-state sodium storage battery in a bipolar configuration, produced with an electrode mixture according to the present invention.

FIG. 5 is a view illustrating a part of the manufacturing process of an all-solid-state sodium storage battery with an electrode mixture according to the present invention.

FIG. 6 is a graph comparing the charge curves of Example 5 and Reference Example 2.

### DETAILED DESCRIPTION OF THE INVENTION

Preferred embodiments of an electrode mixture used for an all-solid-state sodium storage battery with sodium ions serving as carriers, and a storage battery comprising the same according to the present invention are described below.

While the electrode mixture according to the present invention includes a positive electrode mixture (positive electrode active material layer) and a negative electrode mixture (negative electrode active material layer), preferably the electrode mixture used for an all-solid-state sodium storage battery of the present invention contains polyphosphate acid transition metal oxide, regardless of its type of electrode mixture. In particular, when the electrode mixture is used as a positive electrode mixture, the polyphosphate acid transition metal oxide functions as an active material.

In accordance with the electrode mixture according to the present invention, preferably the polyphosphate acid transition metal oxide is crystal represented by the general formula NaₐM_{b}P_{c}O_{d}.

From the perspective that the polyphosphate acid transition metal oxide has high ion conductivity, charging-discharging capacity, or output characteristics, preferably 0.0<a≤3.5, b=1, 1.0≤c≤3.0, and 3.0≤d≤30, and M is at least any one of elements selected from Fe, Mn, Co, Ni and V.

Specifically, the polyphosphate acid transition metal oxide includes Na₂FeP₂O₇, Na₃Fe₂(PO₄)₃, NaFe₃P₃O₁₂, Na₂Fe₃(PO₄)₃, Na₄Fe₃(PO₄)₂(P₂O₇), Na₂MnP₂O₇, Na₂CoP₂O₇, Na₂NiP₂O₇, Na₂Fe_{0.5}Mn_{0.5}P₂O₇, Na₃V₂(PO₄)₃, NaVOPO₄, Na₉V₃(P₂O₇)₃(PO₄)₂, and the like, and one or two or more thereof may be used.

Among the above polyphosphate acid transition metal oxide, from the perspective that the oxide that comprises glass or crystallized glass as a precursor of the polyphosphate acid transition metal oxide has characteristics of being easily synthesized and easily softening and flowing during firing (heat treatment) process at 700° C. or below for crystallization, more preferably 0.0<a≤3.0, b=1, 1.1≤c≤2.9, and 3.5≤d≤12, yet more preferably 0.7≤a≤2.4, b=1, 1.2≤c≤2.8, and 4.0≤d≤11, and desirably 1.7≤a≤2.3, b=1, 1.4≤c≤2.7, and 5.0≤d≤10.

The polyphosphate acid transition metal oxide may be a material in which Li or K is substituted at a part of the Na site, and F, Cl, S or B is substituted at a part of the O site or P site of the above material.

The crystal of polyphosphate acid transition metal oxide can be manufactured from the precursor of polyphosphate acid transition metal oxide. For example, the mixture of sodium metaphosphate (NaPO₃), ferric oxide (Fe₂O₃), and orthophosphate (H₃PO₄), that is to become a given composition, is fired at 1000° C. to 2000° C. for 0.1 to 10 hours in an ambient atmosphere, and once the mixture is melted, the molten glass is poured between a pair of rollers while being rapidly cooled (to 50° C./min or more), which enables the obtainment of glass or polycrystalline glass of polyphosphate iron oxide. The resulting glass or polycrystalline glass of polyphosphate iron oxide is mechanical pulverized and adjusted to obtain an active material precursor having a particle size within the range of 0.1 μm to 100 μm, and fired at 400 to 800° C., which enables the obtainment of crystal of polyphosphate iron oxide.

Although the material may be synthesized in the atmosphere, preferably the material is synthesized in a reducing gas environment comprising 1 or more volume % of hydrogen from the perspective that it will enable the obtainment of polyphosphate acid transition metal oxide with superior crystallinity. It should be noted that the firing should be performed in the gas environment mixed with inert gas, in consideration of the explosion limit of hydrogen since there is an explosion risk associated with firing in the gas environment comprising hydrogen. The inert gas may be any inert gas such as nitrogen or noble gas.

Further, although the firing temperature to obtain the crystal of polyphosphate iron oxide is set within the range from 400 to 800° C., it varies depending on the material of the polyphosphate acid transition metal oxide; and thus, preferably it is set to the same temperature as or slightly above the crystallization temperature upon examination of the crystallization temperature of the precursor with a Thermogravimeter-Differential thermal analyzer (TG-DTA) or the like prior to firing. However, at a temperature of 150° C. above the crystallization temperature, a structural change or a compositional change of the material may occur and the material may be pyrolyzed.

The electrode mixture may further comprise an active material used for a sodium ion battery, a sodium metal battery, a sodium air cell, a sodium-sulfur battery, a sodium-metal chloride battery, an all-solid-state sodium storage battery or the like, in addition to the polyphosphate acid transition metal oxide. That is, the electrode mixture may comprise a known sodium metal, a known sodium alloy, or a known sodium ion absorbing material, in addition to the polyphosphate acid transition metal oxide.

When the electrode mixture is used as a positive electrode mixture, the electrode mixture may contain the polyphosphate acid transition metal oxide as well as another positive electrode active material. The positive electrode active material comprises a known material, including a transition metal oxide-based material, sulfur-based material, and solid solution-based material. When the electrode mixture is used as a negative electrode mixture, preferably the electrode mixture contains the polyphosphate acid transition metal oxide as well as another negative electrode active material since a practical energy density cannot be achieved when the electrode mixture contains only the polyphosphate acid transition metal oxide. Preferably the negative electrode active material comprises a known material, including a transition metal oxide-based material, sulfur-based material, sodium metal, sodium-alloying material, or a material capable of reversibly absorbing and desorbing sodium ions or the like.

Preferably the electrode active material (positive electrode active material or negative electrode active material) as mentioned above has a structure in which a plurality of individual particles of the active material having a particle size within the range from 0.1 μm to 100 μm are connected together by crystalline polyphosphate acid transition metal oxide. That is, preferably the electrode mixture forms an active material cluster in which a plurality of individual particles having a particle size within the range from 0.1 μm to 100 μm are connected together.

Here, a particle size means a volume-based median diameter (D50) measured by a laser diffraction/scattering particle size distribution measurement method.

Further, in the all-solid-state sodium storage battery according to the present invention, preferably the foregoing electrode mixture contains an ion conductive assistant in addition to the active material. Preferably the ion conductive assistant is selected from at least any one selected from ethylene carbonate (EC), polyethylene carbonate (PEC), polyethylene glycol (PEG), and polyethylene oxide (PEO).

Containing at least one ion conductive assistant selected from EC, PEC, PEG, and PEO in the electrode mixture enables a reduction in ionic resistance of the electrode mixture.

Various modifications may be made to EC, PEC, PEG, or PEO contained in the electrode mixture without significantly altering the structure or the property (that is, it may be a derivative).

Although it may vary depending on the mass of the electrode mixture, preferably the content of EC, PEC, PEG, or PEO contained in the electrode mixture is within the range of 0.1 mg/cm² to 500 mg/cm², more preferably within the range of 0.2 mg/cm² to 250 mg/cm², and yet more preferably 0.5 mg/cm² to 100 mg/cm².

In accordance with this configuration, the material selected from EC, PEC, PEG, and PEO contained in the electrode mixture functions as an ion conductive assistant for improving the ion conductivity in the electrode mixture. Further, the organic solid electrolyte interposed between the electrode mixture and the inorganic solid electrolyte is fused and integrated with the electrode mixture, which results in a battery with low impedance. This allows the all-solid-state sodium storage battery to maintain a high discharging capacity in a room temperature environment and exhibit excellent charge-discharge cycle characteristics, even if the electrode mixture is formed with a large thickness.

Further, when the battery is overcharged, the material selected from EC, PEC, PEG, and PEO contained in the electrode mixture is oxidatively decomposed, thereby functioning to suppress the battery voltage increase.

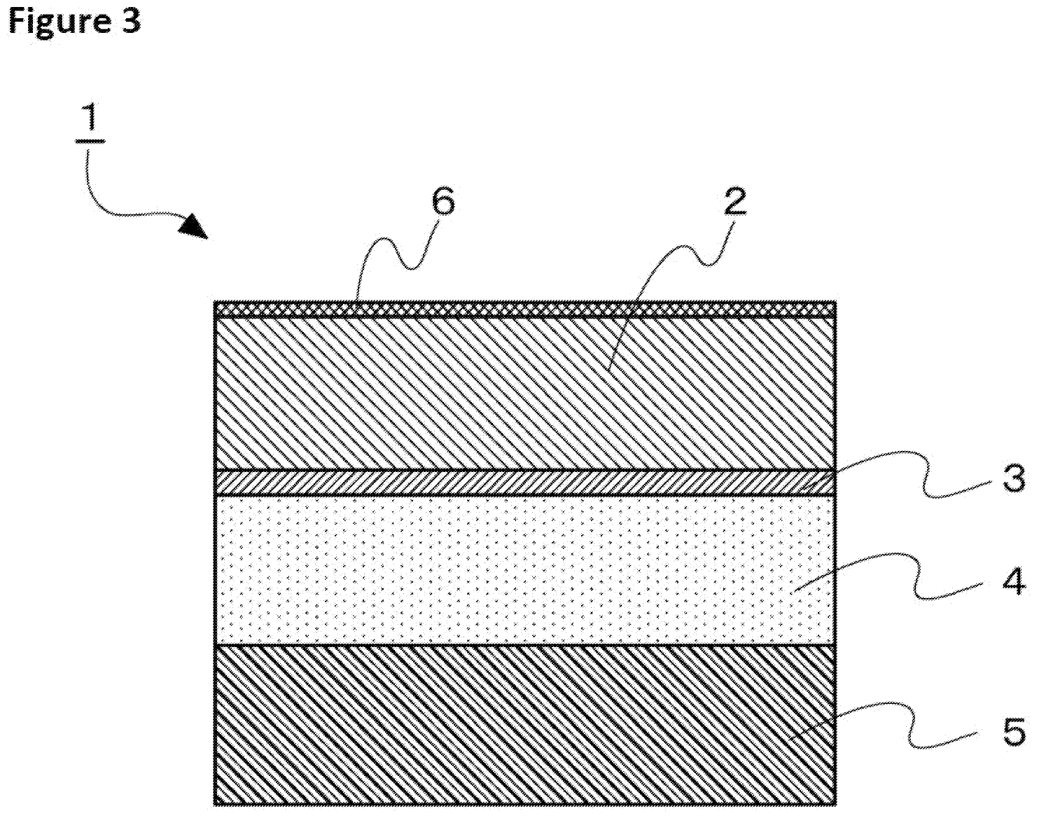

FIG. 3 is a schematic cross-sectional view of an all-solid-state sodium storage battery produced with an electrode mixture according to the present invention. The all-solid-state sodium storage battery 1 shown in FIG. 3 is characterized in that the organic solid electrolyte 3 is configured to be interposed between the electrode mixture 2 (active material layer) and the inorganic solid electrolyte 4. According to this configuration, the organic solid electrolyte 3 can move sodium ions through the electrode mixture 2 and the inorganic solid electrolyte 4 upon application of voltage.

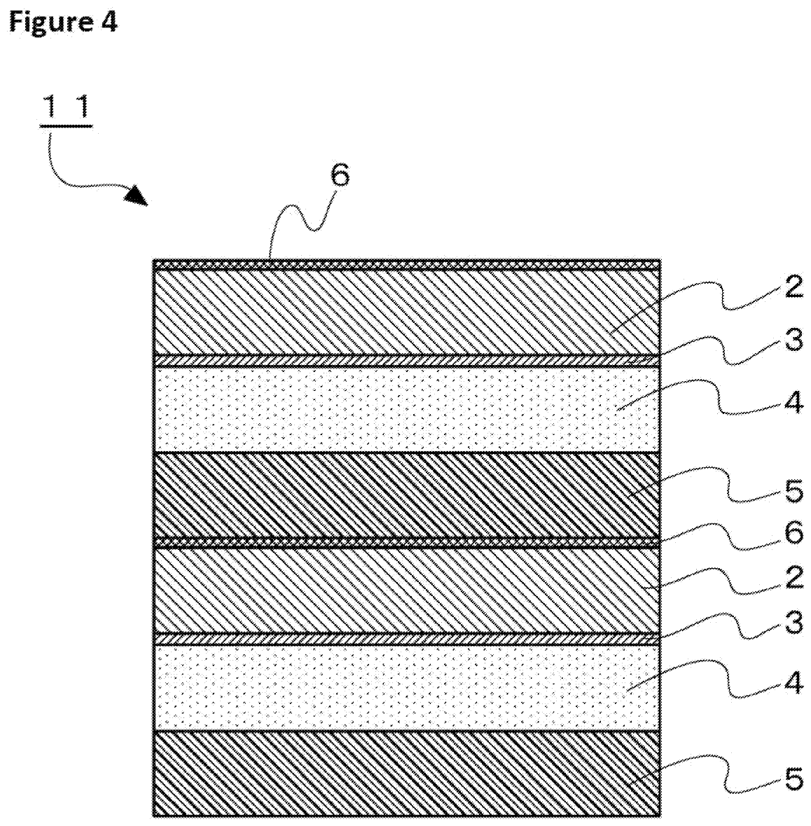

FIG. 4 is a schematic cross-sectional view of an all-solid-state sodium storage battery in a bipolar configuration, produced with an electrode mixture according to the present invention. The all-solid-state battery in a bipolar configuration can achieve a high voltage in one cell.

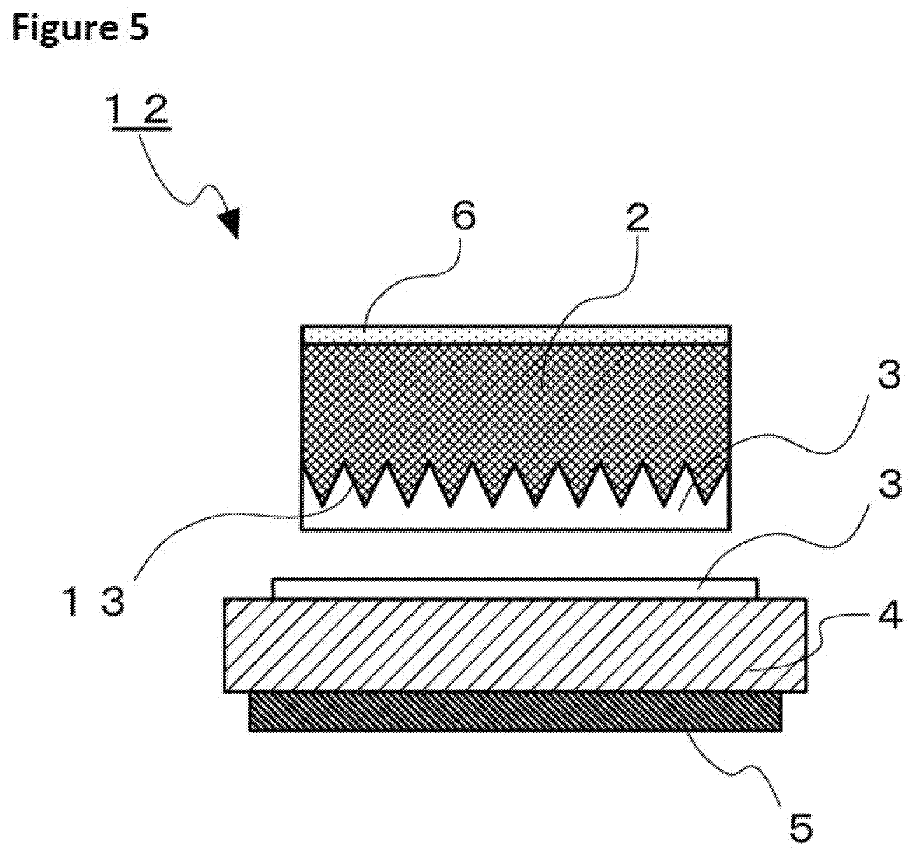

FIG. 5 is a view illustrating a part of the manufacturing process of an all-solid-state sodium storage battery with an electrode mixture according to the present invention. As shown in FIG. 5, the electrode mixture 2 and the inorganic solid electrolyte 4 are adhered via the organic solid electrolyte 3. Specifically, the organic solid electrolyte 3 is applied to one surface of the electrode mixture 2 as well as the organic solid electrolyte 3 is applied to one surface of the inorganic solid electrolyte 4, and the electrode mixture 2 and the inorganic solid electrolyte 4 are adhered in this state. In order to improve the adhesiveness between the electrode mixture 2 and the inorganic solid electrolyte 4, preferably the electrode mixture 2 is provided with a roughened face 13 on the surface.

Among the material selected from EC, PEC, PEG, and PEO contained in the electrode mixture, the polymer material selected from PEC, PEG, and PEO having a molecular weight of 500 or more, is preferable, and PEG or PEO is more preferable, from the perspective that such material has excellent heat resistance for the electrode mixture and high ion conductivity as well as such material is easily fused with the organic solid electrolyte interposed between the electrode mixture and the inorganic solid electrolyte. It should be noted that when a polymer material having a molecular weight more than 200,000 is used, the viscosity becomes so high that there are difficulties in containing it in the electrode mixture upon manufacturing, which cause a decrease in ion conductivity of the electrode mixture. These materials may be either crosslinked materials or non-crosslinked materials.

Further, preferably the electrode mixture comprises an electron conductive assistant. The electron conductive assistant includes but not particularly limited to, for example, metal, carbon material, conductive polymer, conductive glass and the like, as long as it has electron conductivity, but a carbon material is preferable from the perspective that it has a high electron conductivity and a low specific gravity. Specifically, the carbon material includes acetylene black (AB), Ketjen black (KB), furnace black (FB), thermal black, lamp black, channel black, roller black, disk black, carbon black (CB), glassy carbon and the like, and one or two or more thereof may be used.

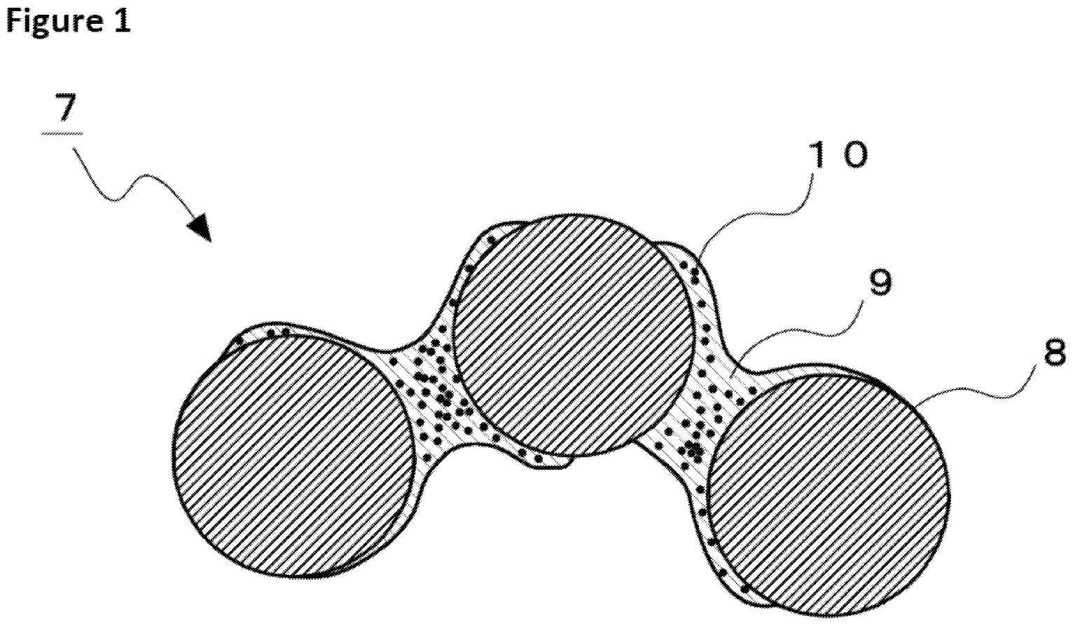

Among these, preferably the electron conductive assistant is carbon having a primary particle size within the range of 1 nm to 100 nm. With such carbon, when forming an active material cluster with a plurality of individual particles connected together, the electrode mixture can form the cluster in such a manner that carbon 10 is contained within a part (polyphosphate acid transition metal oxide crystal 9) that connects the individual particles (electrode active material particles 8) and the individual particles (electrode active material particles 8) as shown in FIG. 1. According to this configuration, carbon serving as an electron conductive assistant improves the electron conductivity between the particles of the electrode active material. This allows a significant improvement in output characteristics of the battery.

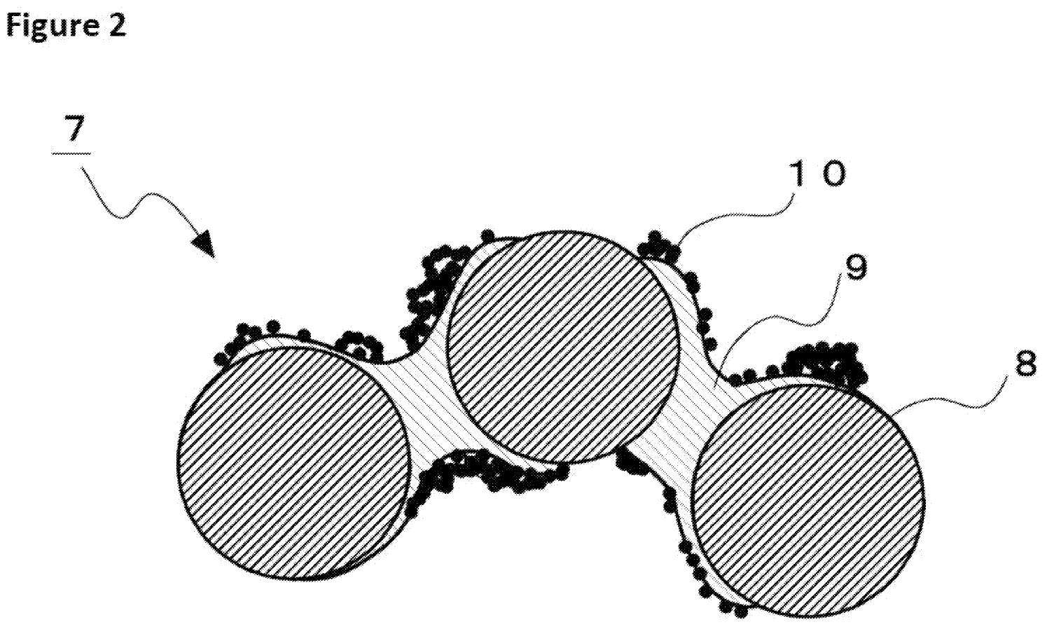

Further, the electron conductive assistant is carbon having a nitrogen adsorption specific surface area within the range of 20 m²/g to 500 m²/g is preferable. With such carbon, when forming an active material cluster with a plurality of individual particles connected together, the electrode mixture can form the cluster in such a manner that carbon 10 is loaded on the surface of a part (polyphosphate acid transition metal oxide crystal 9) that connects the individual particles (electrode active material particles 8) and the individual particles (electrode active material particles 8) as shown in FIG. 2. According to this configuration, carbon serving as an electron conductive assistant improves the electron conductivity of the electrode mixture since carbon is present in the connection between the particles of the active material. This allows a significant improvement in output characteristics of the battery.

Preferably the electron conductive assistant as mentioned above comprises fibrous carbon having a fiber size within the range of 1 nm to 300 nm, or flaky carbon having a thickness within the range of 1 nm to 300 nm. This will lead to less likelihood of the conductive network being broken when the electrode mixture undergoes a change in volume during charging and discharging, and thus an improvement in cycle life characteristics of the battery.

Here, the fiber size refers to a diameter determined by observing the cross section of the fibrous carbon with a transmission electron microscope (TEM). Further, the thickness refers to a thickness determined by observing the cross section of the flaky carbon with a transmission electron microscope (TEM).

The fibrous carbon includes carbon fiber (e.g. vapor-grown carbon fiber named VGCF (registered trademark)), and carbon nanotubes (CNT). The flaky carbon includes flake graphite and graphene.

Preferably the electron conductive assistant contained in the electrode mixture is contained by 0.5 to 30 mass % to the electrode mixture.

A method for manufacturing the electrode mixture is described below for reference. The electrode mixture as mentioned above can be manufactured by filling the powder comprising at least polyphosphate acid transition metal oxide into a powder molding die, pressure-molding it into the form of a pellet (tablet), and then firing it at a temperature between 400° C. and 2000° C. in an inert gas atmosphere or a reducing gas atmosphere.

However, since high pressure more than 100 MPa is required to pelletize the polyphosphate acid transition metal oxide powder, it is necessary to use a large-scale pressure apparatus. For this reason, preferably the above polyphosphate acid transition metal oxide is covered with or loaded on resin binders. If the surface of the polyphosphate acid transition metal oxide is covered with or loaded on the resin binders, the powder can be pelletized with pressure of 100 MPa or less.

The resin binders are adhered to each other with a pressure between 1 MPa and 100 MPa by pressure-molding such powder, and a dense pellet can be obtained. The resin binders are less likely to be adhered to each other with pressure less than 1 MPa during pressure-molding. In contrast, with pressure more than 100 MPa, it is necessary to use a large-scale apparatus.

The resulting pellet is further fired in an inert gas atmosphere or a reducing gas atmosphere to obtain an electrode mixture in which the polyphosphate acid transition metal oxide is easily softened and flowed and integrated. Simultaneously, the resin binders are pyrolyzed. Therefore, the electrode mixture (pellet after firing) does not comprise resin, resulting in a porous electrode mixture having a porosity within the range of 5% to 50%.

That is, in the all-solid-state sodium storage battery according to the present invention, preferably the electrode mixture does not comprise a resin binder. If the electrode mixture comprises resin binders, the resin binders cause an increase in electronic resistance and ion resistance. Further, if the electrode mixture is produced upon firing of the active material precursor, the resin binders lose its binding function as binders due to pyrolysis, and cause a decrease in performance of the active material and the solid electrolyte due to moisture vapor generated at the time of pyrolysis.

A resin binder refers to a binder of a compound having carbon as a primary molecular framework, including materials such as, for example, polyvinylidene fluoride (PVDF), polytetrafluoroethylene (PTFE), polyimide (PI), polyamide, polyamide imide, polyacrylate, styrene-butadiene rubber (SBR), ethylene-vinyl acetate copolymer (EVA), polypropylene carbonate (PPC), styrene ethylene butylene styrene copolymer (SEBS), carboxymethyl cellulose (CMC), xanthan gum, polyvinyl alcohol (PVA), polyvinyl butyral (PVB), ethylene vinyl alcohol, polyethylene (PE), polypropylene (PP), polyacrylate, lithium polyacrylate, sodium polyacrylate, potassium polyacrylate, ammonium polyacrylate, methyl polyacrylate, ethyl polyacrylate, amine polyacrylate, polyacrylic ester, epoxy resin, polyethylene terephthalate (PET), polybutylene terephthalate (PBT), nylon, polyvinyl chloride, silicone rubber, nitrile rubber, cyanoacrylate, urea formaldehyde resin, melamine resin, phenol resin, latex, polyurethane, silylated urethane, nitrocellulose, dextrin, polyvinylpyrrolidone, vinyl acetate, polystyrene, chloropropylene, resorcinol resin, polyaromatics, modified silicone, methacrylate resin, polybutene, butyl rubber, 2-propenoic acid, cyanoacrylic acid, methyl methacrylate, glycidyl methacrylate, acrylic oligomer, 2-hydroxyethyl acrylate, polyacetal, alginic acid, starch, sucrose, lacquer, glue, casein, and the like.

Although many of these resin binders are pyrolyzed and carbonized at 150° C. or above, polypropylene carbonate (PPC) binders are converted to carbon dioxide by heat treatment at 200° C. or above, even in an inert environment or a reducing environment, removing carbon completely, and having very limited effects on the electrode, and thus, they are more preferable. Carbon generated by the pyrolysis of the resin binders may have negative effects on the electrode due to their low conductivity, unless they are fired at a high temperature.

In an electrode mixture configured to further comprise an active material used for a sodium ion battery, a sodium metal battery, a sodium air cell, a sodium-sulfur battery, a sodium-metal chloride battery, an all-solid-state sodium storage battery or the like, in addition to the polyphosphate acid transition metal oxide, preferably not only the polyphosphate acid transition metal oxide but also these active materials are covered with or loaded on the resin binders. The same applies to an electrode mixture to which an electron conductive assistant is added.

The firing conditions are not particularly limited as long as the material is maintained at a temperature within the range of 400° C. to 2000° C. for 5 minutes or more in an inert gas atmosphere or a reducing gas atmosphere; however, preferably the material is heated within the range of 0.1° C./min to 50° C./min and maintained at a temperature between 400° C. and 2000° C. during a period of 5 minutes or more and 10 hours or less from the perspective that the polyphosphate acid transition metal oxide is softened and flowed, and the resin binders are pyrolyzed.

Preferably, the electrode mixture after firing has a thickness within the range of 10 μm to 5000 μm and a total weight per unit area within the range of 1 mg/cm² to 5000 mg/cm² from the perspective of input and output characteristics and energy density of the battery.

The polyphosphate acid transition metal oxide covered with the resin binders can be obtained by adding a solvent to the mixed powder consisting of polyphosphate acid transition metal oxide and resin binders and mixing them followed by removing the solvent by volatilization and pulverizing or classifying the mixture. This process should be carried out in a dry environment (with a dew point of −40° C. or below), unless the solvent is water.

As a means for producing the above mixed powder or adding a solvent and mixing them, a known mixing means may be used, including, for example, a tumbling mill, vibrating mill, planetary mill, rocking mill, horizontal mill, attritor mill, jet mill, grinding mixer, homogenizer, fluidizer, paint shaker, and mixer.

As a method for removing the solvent by volatilization and pulverizing or classifying the mixture, a known granulation method can be applied, including, for example, fluidized bed granulation method, stirring granulation method, tumbling granulation method, spray drying method, extrusion granulation method, and coating granulation method. Among these, a spray drying method and a fluidized bed granulation method are particularly preferable.

In a spray drying method, granules can be obtained by, for example, spraying a suspension in which polyphosphate acid transition metal oxide and resin binders are dispersed from above to a chamber heated between 50° C. and 300° C. at a rate of 1 to 30 mL/min under air pressure between 0.01 and 5 MPa to form agglomerated granules, and drying them.

In a fluidized bed granulation method, granules can be obtained by, for example, placing powder raw materials in a fluidized bed granulator, flowing and mixing the powder raw materials (granule precursors) by sending warm air heated between 50 and 300° C. from below, spraying a liquid in which resin binders are dissolved or dispersed through a nozzle from above to the mixed powder raw materials so that the resin binders are uniformly sprayed to the powder surface at a rate of 1 to 30 mL/min under air pressure of 0.01 to 5 MPa to form agglomerated granules, and drying them.

The electrode mixture can comprise a material selected from EC, PEC, PEG, and PEO upon mixture of such material with the active material and pelletizing them; however, when the battery is manufactured by producing the crystal of polyphosphate acid transition metal oxide upon firing of polycrystalline glass or glass of polyphosphate acid transition metal oxide, the electrode mixture cannot contain EC, PEC, PEG, or PEO due to pyrolysis of EC, PEC, PEG, or PEO upon firing of the glass previously comprising EC, PEC, PEG, or PEO. For this reason, it is necessary to contain a material such as EC, PEC, PEG, PEO or the like after firing polycrystalline glass or glass of polyphosphate acid transition metal oxide.

Therefore, the electrode mixture can comprise a material selected from EC, PEC, PEG, and PEO by applying EC, PEC, PEG, PEO or the like in a liquefied state to the polyphosphate acid transition metal oxide after firing, or immersing the polyphosphate acid transition metal oxide after firing in EC, PEC, PEG, PEO or the like in a liquefied state.

EC, PEC, PEG, PEO or the like may be liquefied by heating the subject material to a higher temperature; however, preferably it is liquefied by adding an organic solvent. The organic solvent is not particularly limited as long as it can dissolve and liquefy the subject material. The organic solvent includes, for example, a linear hydrocarbon solvent (DMC, DEC, EMC, dichloromethane, alcohols and the like), a cyclic hydrocarbon solvent (NMP, benzene, lactones, and the like), and the like. Preferably the organic solvent is removed by pressure reduction or heat treatment. For example, a drying method for an electrode slurry used for a lithium ion battery may be adopted.

When the electrode mixture has a large thickness, EC, PEC, PEG, PEO or the like does not easily infiltrate by merely applying liquefied EC, PEC, PEG, PEO or the like, and therefore, preferably the polyphosphate acid transition metal oxide after firing is immersed in liquefied EC, PEC, PEG, PEO or the like. Further, when the polyphosphate acid transition metal oxide in this state is placed in a reduced pressure environment, EC, PEC, PEG, PEO or the like can be infiltrated deep into the pores contained in the polyphosphate acid transition metal oxide after firing. The condition of reduced pressure environment may be any as long as the pressure is lower than the atmospheric pressure (negative pressure), and for example, a negative pressure environment having gauge pressure of 0 MPa to −0.1 MPa may be established with a vacuum pump.

Preferably the above electrode mixture is porous with a porosity ranging from 5% to 50% when excluding the material selected from EC, PEC, PEG and PEO contained in the electrode mixture. With a porosity less than 5%, the electrode mixture cannot contain EC, PEC, PEG or PEO sufficiently. With a porosity more than 50%, the electrode mixture can contain EC, PEC, PEG, PEO or the like abundantly, but the energy density decreases due to a decrease in the ratio of the active material in the electrode mixture.

Here, a porosity refers to a value determined from the apparent density of the subject and the true density of the configuration material according to the following formula: porosity (%)=100−(apparent density of the subject/true density of constituent material)×100.

Preferably the above electrode mixture is porous with a plurality of pores having a pore size of 0.1 μm to 100 μm, when excluding the material selected from EC, PEC, PEG and PEO contained in the electrode mixture. When the pores have a pore size outside of the foregoing range, the electrode mixture has difficulty in containing EC, PEC, PEG, PEO or the like sufficiently during the manufacturing of the electrode mixture. That is, when the pores have a pore size less than 0.1 μm, EC, PEC, PEG, PEO or the like has difficulty in infiltrating the electrode mixture, and in contrast, when the pores have a pore size more than 100 μm, the strength of the electrode mixture decreases and the electrode mixture is more likely to be damaged.

Preferably the electrode mixture according to the present invention does not comprise a resin binder.

Preferably when there are pores in the electrode mixture according to the present invention, the surfaces of the pores are covered with an electrolyte as an ion conductive assistant.

The above electrolyte contains at least any one selected from EC, PEC, PEG, and PEO in addition to an alkali metal salt.

Further, the present invention relates to an all-solid-state sodium storage battery with sodium ions serving as carriers, in which the above electrode mixture is used as a positive electrode and/or a negative electrode.

Further, preferably the all-solid-state sodium storage battery according to the present invention is configured such that the organic solid electrolyte as mentioned above is a polyether or a derivative thereof obtained by polymerizing ethylene glycol, in particular, is configured to include specifically polyethylene glycol (PEG) or polyethylene oxide (PEO). The foregoing PEG or the foregoing PEO has a function as an adhesive to bond the electrode mixture and the inorganic solid electrolyte, in addition to the function as a solid electrolyte.

The above PEG or PEO may comprise a sulfuric compound functional group, a nitrogen compound functional group, a phosphorus-compound functional group, or an acrylate functional group.

Further, preferably the above PEG or PEO is a polyether or a derivative thereof obtained by polymerizing ethylene glycol, in which the weight average molecular weight (Mw) is 1000 or more and 1,000,000 or less, from the perspective that it has an excellent function as an adhesive to bond the electrode mixture and the inorganic solid electrolyte.

In particular, when the electrode mixture or the inorganic solid electrolyte to be adhered has concave and convex or a gap on the surface, the above organic solid electrolyte enters into the concave and convex or the gap of the electrode mixture or the inorganic solid electrolyte to be adhered, resulting in an increase in contact area between the electrode mixture and the inorganic solid electrolyte, and thus resulting in a decrease in ion resistance of the battery.

Preferably the above organic solid electrolyte is liquefied and applied to the electrode mixture and/or the inorganic solid electrolyte. The above organic electrolyte may also be a nonflammable ionic liquid. The organic solid electrolyte can be liquefied by dissolving the subject material with an organic solvent. This organic solvent is not particularly limited as long as it is a solvent capable of dissolving the subject material, including solvents such as a linear hydrocarbon solvent and a cyclic hydrocarbon solvent. A linear hydrocarbon solvent includes diethyl carbonate (DMC), diethyl carbonate (DEC), ethyl methyl carbonate (EMC), tert-butylperoxy isopropyl carbonate, dichloromethane, nitriles, alcohols and the like, and a cyclic hydrocarbon solvent includes N-methyl-2-pyrrolidone (NMP), ethylene sulfite, vinyl ethylene carbonate (VEC), propylene carbonate (PC), 1,3-dioxolan-2-one, benzene, lactones and the like.

The nonflammable ionic liquid is not particularly limited as long as it has an ion conductivity, including, for example, a cation-based, in particular, a pyridine-based, alicyclic amine-based, and aliphatic amine-based nonflammable ionic liquids of cation. Various nonflammable ionic liquids can be synthesized by selecting different types of anion to be combined therewith. Examples of cation include imidazolium salts, pyridinium salts, phosphonium ions, inorganic ions and the like, and examples of anion include bromide ions, triflate, tetraphenylborate, hexafluorophosphate, and the like.

The nonflammable ionic liquid can be obtained by a known synthetic method, for example, a synthetic method by combining a cation such as imidazolium with an anion such as Br⁻, Cl⁻, BF₄⁻, PF₆⁻, (CF₃SO₂)₂N⁻, CF₃SO₃⁻, or FeCl₄⁻. Such nonflammable ionic liquid can function as an electrolyte.

The function of the battery can be achieved even if the above organic solvent is present together with the electrode material to some extent at the time of assembling the battery; however, preferably the organic solvent is sufficiently removed by pressure reduction or heat treatment in order to suppress the expansion of the battery due to volatilization of the organic solvent. The removing method is not particularly limited, but, for example, a drying method for an electrode slurry used for a lithium ion battery may be adopted.

When the electrode mixture or the inorganic solid electrolyte to be adhered is porous, the above organic solid electrolyte flows in through the pores on the surface of the electrode mixture or the inorganic solid electrolyte to be adhered, which enables a significant decrease in resistance derived from the ion conductivity of the battery (ion resistance).

Further, the above organic solid electrolyte is equipped with a shutdown function to separate the electrode mixture and the inorganic solid electrolyte, and thus increase the impedance of the battery since when the battery is overcharged, the foregoing PEG or PEO is oxidatively decomposed, suppressing the battery voltage increase as well as stopping the function as an adhesive.

A higher molecular weight of the foregoing PEG or PEO is more preferable from the perspective that it strongly binds to the electrode mixture and the solid electrolyte; however, when the weight average molecular weight is more than 1,000,000, the viscosity becomes so high that not only the handling becomes difficult but also the ion conductivity becomes low when the organic solid electrolyte contains a sodium salt as mentioned below. In contrast, when the weight average molecular weight is less than 1000, the adhesiveness is insufficient such that it is likely to cause a break in the interface between the electrode mixture and the inorganic solid electrolyte and therefore an increase in impedance of the battery when a vibration or a shock is applied to the battery. When the molecular weight is low, the PEG or PEO is found to have hygroscopicity and the drying process takes time. Thus, preferably the weight average molecular weight is 1000 or more, more preferably 2500 or more, with the upper limit of 1,000,000. These materials may be either crosslinked materials or non-crosslinked materials.

The weight average molecular weight can be determined by, for example, measuring by gel permeation chromatography (GPC) methodology using liquid chromatography.

Preferably the above organic solid electrolyte further comprises a sodium salt from the perspective that it has a higher ion conductivity.

If the weight of the organic solid electrolyte is 1, preferably the weight of sodium salt is 0.1 or more, more preferably 0.3 or more, and yet more preferably 0.4 or more. However, when the content of sodium salt is too great, the viscosity of the organic solid electrolyte increases and the adhesive property between the electrode and the solid electrolyte decreases; therefore, preferably the content of sodium salt is 1.5 or less, more preferably 1.2 or less, and yet more preferably 0.7 or less. When an organic solid electrolyte with a lower adhesive property is used, the battery has inferior charge-discharge cycle characteristics.

Used as a sodium salt is at least one selected from the group consisting of sodium hexafluorophosphate (NaPF₆), sodium perchlorate (NaClO₄), sodium tetrafluoroborate (NaBF₄), sodium trifluoromethanesulfonate (NaCF₃SO₄), sodium bisoxalate borate (NaBC₄O₈), sodium difluorophosphate (F₂NaO₂P), sodium bis(fluorosulfonyl)imide (F₂NaNO₄S₂), sodium difluoroborate (NaBF₂O) and the like. Among the above sodium salts, NaPF₆ is preferable since it has a particularly high electronegativity and is easily ionized. As long as the organic solid electrolyte contains NaPF₆, the battery has excellent input and output characteristics and charge-discharge cycle characteristics.

Preferably the above organic solid electrolyte has a thickness within the range of 0.1 μm to 500 μm, more preferably within the range of 0.2 μm to 100 μm, yet more preferably 0.5 μm to 50 μm, and desirably 1 μm to 20 μm from the perspective that it has excellent ion conductivity and will boost the energy density of the battery. Alternatively, preferably the above organic solid electrolyte has a volume per unit area within the range of 0.1 mg/cm² to 800 mg/cm², more preferably 0.2 mg/cm² to 500 mg/cm², yet more preferably 0.5 mg/cm² to 100 mg/cm², and desirably 1 mg/cm² to 20 mg/cm².

The inorganic solid electrolyte includes a sulfide-based, oxide-based or hydride-based solid electrolyte, any one of which may be used alone or two or more of which may be used in combination. Preferably such inorganic solid electrolyte has a thickness of 1 mm or less and a porosity of 20% or less from the perspective that it will boost the energy density as well as the ion conductivity of a battery.

The sulfide-based solid electrolyte includes, for example, A₄SiS₄, A₄GeS₄, A₃PS₄, A_{9.54}Si_{1.74}P_{1.44}S_{11.7}C_{10.3}, A₁₀GeP₂S₁₂, A_{3.25}Ge_{0.25}P_{0.75}S₄, A₆PS₅Cl, A₂S—B₂S₃·AI, A₂S—P₂S₅-ABH₄, A₂S-SiS₂·A₄SiO₄, A₂S—P₂S₅, A₇P₃S₁₁, A_{3.25}P_{0.95}S₄ and the like (A represents Na or other alkali metal elements including Na).

The oxide-based solid electrolyte includes, for example, A_{1.3}Al_{0.3}Ti_{1.7}(PO₄)₃, A_{0.34}La_{0.51}TiO_{2.94}, A₇LaZr₂O₁₂, A₄SiO₄·A₂BO₃, A₃PO₄-A₄SiO₄, A₃BO₃-A₂SiO₄, A₃BO₃-A₂SO₄, A_{2.9}PO_{3.3}N_{0.46}, A_{1.07}Al_{0.69}Ti_{1.46}(PO₄)₃, A_{3.3}PO_{3.8}N_{0.22}, A_{2.9}PO_{3.3}N_{0.46} (A represents Na or other alkali metal elements including Na), crystalline NASICON (Na₁₊ₓZr₂SiₓP₃₋ₓO₁₂, 0<x<3), aluminum oxide containing sodium and the like.

The hydride-based solid electrolyte also includes, for example, ABH₄, ABH₄-Al, ABH₄-ABr, ABH₄-AF, ABH₄-ACl and the like (A represents an alkali metal element).

Preferably the above inorganic solid electrolyte also has a porosity within the range of 0% to 20%. That is, the above inorganic solid electrolyte may be as dense an inorganic solid electrolyte as possible. The above inorganic solid electrolyte can boost the ion conductivity when having a porosity of 20% or less. In contrast, the above inorganic solid electrolyte has a poor ion conductivity when having a porosity more than 20%, which is likely to cause minor short circuits during charging.

In other words, preferably the above inorganic solid electrolyte has a density within the range of 2.7 g/cc to 3.5 g/cc. The above inorganic solid electrolyte has too many pores and a poor ion conductivity when having a density less than 2.7 g/cc, which is likely to cause minor short circuits during charging.

However, it is not realistic to manufacture an inorganic solid electrolyte having a porosity of 0%, unless a single crystal is used. Therefore, preferably the pores of the inorganic solid electrolyte are infiltrated with the organic solid electrolyte in order to further improve the ion conductivity. Here, when having a density more than 3.5 g/cc, the inorganic solid electrolyte is not easily infiltrated with the organic solid electrolyte, and thus, preferably the inorganic solid electrolyte has a density of 3.5 g/cc or less.

The above density means a density when a container having a certain volume capacity is filled with the inorganic solid electrolyte and the volume capacity is regarded as a volume, more specifically, bulk density.

Although the shape of the inorganic solid electrolyte is not particularly limited, it may be molded into any of a film shape, a sheet shape, a pellet shape, or a ribbon shape.

Preferably the above inorganic solid electrolyte is an oxide-based inorganic solid electrolyte from the perspective that it is less likely to generate toxic gas when brought into contact with water. Among them, preferably the above inorganic solid electrolyte is aluminum oxide containing sodium since it has excellent electrical insulation and heat resistance.

Aluminum oxide containing sodium is crystal or ceramics represented by the general formula Na₂O-xAl₂O₃ (x=2 to 20), having a structure in which sodium ions are distributed between two-dimensional layers made of alumina blocks. Although β-alumina (Na₂O-11Al₂O₃) and β″-alumina (β-double prime alumina (Na₂O-5Al₂O₃)) are known based on the overlap pattern of alumina blocks, either functions as the solid electrolyte since sodium ions move between the two-dimensional layers made of alumina blocks.

Aluminum oxide containing sodium can be synthesized by, for example, firing the mixture consisting of α-alumina (Al₂O₃) and sodium carbonate at 1100° C. to 1500° C.

Preferably aluminum oxide containing sodium further contains at least one metal selected from Mg, Li, K, Rb, Zr, Pb, Y, Ag, Tl, Sr, Ca, and Fe or oxide thereof. Preferably the content of such metal or oxide is 5 or less volume % with respect to the aluminum oxide containing sodium. This allows for easier obtainment of aluminum oxide containing dense sodium, which can further improve the ion conductivity.

The above inorganic solid electrolyte may be contained in the electrode mixture in the form of powder having a particle size of 0.1 μm to 100 μm.

An all-solid-state sodium storage battery according to the present invention can be manufactured by, for example, obtaining the electrode mixture in a manner as mentioned above, bringing the electrode mixture into close contact with one surface of the inorganic solid electrolyte via the organic solid electrolyte in a dry environment with a dew point temperature of −40° C. or below, providing a counter electrode on another surface of the inorganic solid electrolyte, and sealing them.

The electrode mixture of the present invention can be used as a high loading electrode. Preferably the electrode mixture of the present invention has a thickness of 10 μm to 5000 μm, more preferably 200 μm to 4000 μm, and yet more preferably 500 μm to 3000 μm. Preferably the electrode mixture of the present invention has a total weight per unit area of 1 mg/cm² to 5000 mg/cm², more preferably 160 mg/cm² to 4800 mg/cm², and yet more preferably 400 mg/cm² to 3600 mg/cm².

The counter electrode is not particularly limited, and when the electrode mixture is used as a positive electrode mixture, an electrode mixture containing a negative electrode active material or, alternatively, a known sodium metal negative electrode, a known sodium alloy negative electrode or a known sodium ion intercalation negative electrode can be used as a counter electrode. When the electrode mixture is used as a negative electrode mixture, a positive electrode mixture or, alternatively, a known sodium alloy positive electrode or a known sodium ion intercalation positive electrode can be used as a counter electrode.

Preferably the all-solid-state sodium storage battery is configured to have the above organic solid electrolyte interposed between the counter electrode and the inorganic solid electrolyte.

The electrode mixture and the all-solid-state sodium storage battery comprising the same have been described as above, but various additions, changes and deletions may be made without departing from the spirit of the invention. For example, the electrolyte of the all-solid-state sodium storage battery of the present invention may be one obtained by further adding an electrolyte solution, an ionic liquid, or a gel electrolyte. For example, the battery may be converted to a non-aqueous electrolyte storage device comprising alkali metal ions as carriers, by changing the carrier ions of the battery from sodium ions to other alkali metal ions (such as lithium ions or potassium ions).

An assembled battery in one aspect of the present invention is characterized by comprising all-solid-state sodium storage batteries of the present invention. That is, the assembled battery may be any battery pack comprising two or more unit cells in which all-solid-state sodium storage batteries of the present invention are connected to each other directly, or electrically via a busbar.

An electrical apparatus in one aspect of the present invention is characterized by comprising all-solid-state sodium storage batteries or assembled batteries of the present invention.

The electrical apparatus includes, for example, irons, whisks, integrated personal computers, clothes dryers, medical equipment, interphones, wearable terminals, video equipment, air conditioners, air circulators, gardening machines, motorcycles, ovens, music players, music recorders, hot air heaters, toys, car stereo components, flashlights, loudspeakers, car navigation systems, cassette stoves, household storage batteries, nursing machines, humidifiers, dryers, refueling machines, water dispensers, suction machines, safes, glue guns, mobile phones, mobile information devices, air purifiers, jackets with built-in electric fan, game machines, fluorescent lights, fluff removers, cordless phones, coffee makers, coffee warmers, ice scrapers, kotatsu, copy machines, haircut equipment, shavers, lawn mowers, automobiles, lighting equipment, dehumidifiers, sealers, shredders, automatic extracorporeal defibrillators, rice cookers, stereos, stoves, speakers, trouser presses, smartphones, rice mills, washing machines, toilet seats with cleaning function, sensors, fans, submarines, blowers, vacuum cleaners, flying cars, tablets, body fat meters, fishing tackles, digital cameras, TVs, TV receivers, video games, displays, disk changers, desktop computers, railroads, TVs, electric carpets, lamps, electric stoves, electric pots, electric blankets, calculators, electric carts, electric wheelchairs, electric tools, electric cars, electric floats, electric toothbrushes, telephones, electric bicycles, electric shock insecticides, electromagnetic cookers, electronic notebooks, electronic musical instruments, electronic locks, electronic cards, microwave ovens, electronic mosquito repellents, electronic cigarettes, telephones, electric power load leveling system, toasters, dryers, transceivers, watches, drones, food waste disposers, laptops, incandescent bulbs, soldering irons, panel heaters, halogen heaters, fermenters, baking machines, hybrid cars, personal computers, personal computer peripherals, hair clippers, panel heaters, video cameras, video decks, airplanes, emergency lights, emergency storage batteries, ships, beauty equipment, printers, copying machines, crushers, atomizers, facsimiles, forklifts, plug-in hybrid cars, projectors, hair dryers, hair irons, headphones, disaster prevention equipment, security equipment, home theaters, hot sand makers, hot plates, pumps, fragrance machines, massage machines, mixers, mills, movie players, monitors, rice cake makers, water heaters, floor heating panels, radios, radio-cassette players, lanterns, radio controllers, laminators, remote controllers, microwaves, water coolers, refrigerators, portable air coolers, cold air fans, cooling equipment, robots, word processors, and GPS.

### EXAMPLES

Examples of the present invention will be described in more detail below, but the present invention is not limited to these examples. In particular, in the examples, an all-solid-state sodium storage battery comprising β″-alumina as solid electrolyte is described as an example, but the present invention is not limited thereto. As an active material contained in the electrode mixture, Na₂FeP₂O₇ is described as an example, but it is not limited thereto.

### Example 1: Preparation of Electrode Mixture 1

### <Preparation of Positive Electrode Active Material Precursor Powder>

A positive electrode active material precursor was prepared by a melt quenching method. Sodium metaphosphate (NaPO₃), ferric oxide (Fe₂O₃), and orthophosphoric acid (H₃PO₄) were used as raw materials, and they were blended so that the composition comprises, in molar ratio, 40 Na₂O, 20 Fe₂O₃ and 40 P₂O₅, and melted at 1350° C. for 1 hour in an ambient atmosphere. The resulting molten glass was poured between a pair of cooling rollers and formed into a shape while being rapidly cooled, to obtain a film-like glass body having a thickness of 0.1 to 1 mm. The obtained glass body was pulverized with a ball mill with ZrO₂ balls of φ 20 mm for 10 hours, and passed through a sieve made of resin having openings of 120 μm to obtain coarse glass powder having an average particle size of 7 μm. Then, the coarse glass powder was pulverized with a ball mill with ZrO₂ balls of φ 3 mm for 80 hours with ethanol as a pulverization agent, to obtain glass powder (positive electrode active material precursor powder) having an average particle size of 0.6 μm. The glass powder was confirmed to be amorphous as a result of a powder X-ray diffraction measurement.

### <Preparation of Positive Electrode Active Material Powder>

The resulting glass body was crystallized upon firing at 650° C. for 1 hour in a nitrogen atmosphere to obtain a crystalline body. The obtained crystalline body was pulverized with a ball mill with ZrO₂ balls of φ 20 mm for 10 hours, and passed through a sieve made of resin having openings of 120 μm to obtain coarse powder having an average particle size of 7 μm. Then, the coarse powder was pulverized with a ball mill with ZrO₂ balls of φ 3 mm for 12 hours with ethanol as a pulverization agent, to obtain crystalline body powder having an average particle size of 0.2 μm. Polyethylene oxide nonylphenyl ether, a non-ionic surfactant, (weight-average molecular weight: 660) was mixed in an amount of 30 wt. % as a carbon source with respect to 70 wt. % of this crystalline body powder and then dried at 100° C. for 1 hour. Then, the mixture was fired at 620° C. for 30 minutes in a nitrogen atmosphere to obtain positive electrode active material powder having an average particle size of 0.2 μm. This positive electrode active material powder was confirmed to be a diffraction line derived from Na₂FeP₂O₇ crystal as a result of a powder X-ray diffraction measurement.

### <Preparation of Electrode Mixture (Active Material Layer)>

The electrode mixture (active material layer) was prepared by filling the mixture powder covered with polypropylene carbonate (PPC) in a powder molding die (from NPa SYSTEM CO., LTD., φ 10 mm) in an argon environment, pressure-molding it into the form of a pellet with pressure of 30 MPa and firing it at 550° C. for 1 hour with a rate of 3° C./min in a nitrogen (N₂)/hydrogen (H₂) mixed gas (=96/4 volume %) atmosphere, and then depositing a gold at a thickness of 300 nm as a current collector on one side of the pellet by physical vapor deposition (PVD). Since all PPC contained in the electrode mixture was pyrolyzed and converted to carbon dioxide during firing process, the resulting electrode mixture had the weight subtracting the weight of PPC.

The electrode mixture after firing had a thickness of 298 μm, a total weight of 0.0307 g, and a diameter of 9.242 mm, with the active material contained in the electrode mixture in an amount of 0.02794 g. When the SEM (scanning electron microscope) image of the cross section of the electrode mixture was observed, the electrode mixture was confirmed to be a cluster formed of positive electrode active material particles with a plurality of particles connected together and have a porous structure comprising pores. This cluster was formed by softening and flowing the positive electrode active material precursor powder and binding the positive electrode active material powder together during firing of the mixture powder. It was confirmed that the positive electrode active material precursor powder was crystalized while softening and flowing, and precipitating Na₂FeP₂O₇ crystal.

The mixed powder covered with PPC was obtained by adding N-methyl-2-pyrolidone (NMP) to the positive electrode active material precursor powder and the positive electrode active material, the electron conductive assistant, and PPC (32.3:48.5:2.5:16.7 wt. %) and mixing them by a planetary centrifugal mixer (Rentaro from THINKY CORPORATION, 2000 rpm, 1h) in a dry environment (with a dew point of −40° C. or below) and removing NMP by volatilization through drying by heating on a glass plate (80° C., 1h) and then pulverizing the mixture by a grinding machine (AMM-140D from NITTO KAGAKU CO., Ltd.) (1h). As the electron conductive assistant, an electron conductive assistant in which carbon black and vapor grown carbon fibers (VGCF-H from SHOWA DENKO K.K.) were mixed at a ratio of 5:1 wt. % was used.

### Example 2: Preparation of Electrode Mixture 2

For this electrode mixture, the mixed powder covered with PPC was obtained by adding N-methyl-2-pyrolidone (NMP) to the positive electrode active material precursor powder and the positive electrode active material, the electron conductive assistant, and PPC (28:42:7:23 wt. %) and mixing them by a planetary centrifugal mixer (Rentaro from THINKY CORPORATION, 2000 rpm, 1h) in a dry environment (with a dew point of −40° C. or below) and removing NMP by volatilization through drying by heating on a glass plate (80° C., 1h) and then pulverizing the mixture by a grinding machine (AMM-140D from NITTO KAGAKU CO., Ltd.) (1h). As the electron conductive assistant, an electron conductive assistant in which carbon black and vapor grown carbon fibers (VGCF-H from SHOWA DENKO K.K.) were mixed at a ratio of 8:1 wt. % was used. The other conditions were kept same as those of Example 1.

The electrode material after firing had a thickness of 278 μm, a total weight of 0.0304 g, and a diameter of 9.325 mm, with the active material contained in the electrode mixture in an amount of 0.02767 g. When the SEM image of the cross section of the electrode mixture was observed, the electrode mixture was confirmed to be a cluster formed of positive electrode active material particles with a plurality of particles connected together and have a porous structure comprising pores.

### Example 3: Production of All-Solid-State Sodium Storage Battery 1

### <Inorganic Solid Electrolyte and Organic Solid Electrolyte>

For the production of a non-aqueous electrolyte battery of the present invention, an inorganic solid electrolyte and an organic solid electrolyte, both of which were essential elements, were prepared.

As the inorganic solid electrolyte, Li₂O-stabilized β″-alumina of Compositional Formula Na_{1.6}Li_{0.34}Al_{10.66}O₁₇ (from Ionotec Ltd) was used as is. The inorganic solid electrolyte had a thickness of 1 mm.

The organic solid electrolyte was produced by adding acetonitrile to polyethylene glycol (PEG) having a weight average molecular weight (Mw) of 7000 and NaPF₆ (1:0.3 wt.) and mixing them by a planetary centrifugal mixer (Rentaro from THINKY CORPORATION, 2000 rpm, 1h).

### <Production of All-Solid-State Sodium Storage Battery>

The battery of Example 3 was prepared by interposing an organic solid electrolyte having a thickness of 0.005 g/cm² between the electrode mixture of Example 1 and an inorganic solid electrolyte in an argon environment, and using a sodium metal as a counter electrode. The organic solid electrolyte was interposed by applying the organic solid electrolyte dissolved in acetonitrile to the electrode mixture with a brush and vacuum drying it (60° C., 1h).

### Example 4: Production of All-Solid-State Sodium Storage Battery 2

The battery of Example 4 had the same battery configuration as Example 3, except a mixture consisting of PEG and NaPF₆ (1:0.3 wt.) filled into the electrode mixture of Example 1 so as to have a thickness of 0.006 g/cm². The mixture filled into the electrode mixture was filled by immersing the electrode mixture in PEG and NaPF₆ dissolved in acetonitrile followed by vacuum drying (60° C., 1h) for the acetonitrile removal.

### Example 5: Production of All-Solid-State Sodium Storage Battery 3

The battery of Example 5 had the same battery configuration as Example 3, except a mixture consisting of ethylene carbonate (EC) and NaPF₆ (1:0.3 wt %) filled into the electrode mixture of Example 1. The mixture filled into the electrode mixture was filled by immersing the electrode mixture in EC and NaPF₆ dissolved in diethyl carbonate (DEC) followed by vacuum drying (60° C., 1h) for the DEC removal.

### Example 6: Production of All-Solid-State Sodium Storage Battery 4

The battery of Example 6 had the same battery configuration as Example 3, except a mixture consisting of ethylene carbonate (EC) and NaPF₆ (1:0.3 wt %) filled into the electrode mixture of Example 2. The mixture filled into the electrode mixture was filled by immersing the electrode mixture in EC and NaPF₆ dissolved in diethyl carbonate (DEC) followed by vacuum drying (60° C., 1h) for the DEC removal.

### Reference Example 1: All-Solid-State Sodium Storage Battery

The battery of Reference Example 1 had the same battery configuration as Example 3, except without an organic solid electrolyte.

### Reference Example 2: Liquid Sodium Ion Battery

The battery of Reference Example 2 had the same battery configuration as Reference Example 1, except with a material obtained by impregnating a separator of a glass non-woven fabric (GA-100 from Advantech Co., Ltd.) and a polyolefin microporous film (#2320 from Celgard LLC.) stacked together in 1M NaPF₆/(EC:DEC=1:1 vol.), instead of comprising an organic solid electrolyte and an inorganic solid electrolyte.

### <Battery Test>

The battery was tested by repeating constant current charging and discharging at 60° C., at a rate of 0.01C, and at a cutoff voltage 3.8-2.0V. The test results of charging and discharging of Examples 3 to 6 and Reference Examples 1 and 2 are shown below.

### Example 3

For the all-solid-state sodium storage battery of Example 3, the electrode mixture and the inorganic solid electrolyte were integrated by interposing the mixture consisting of PEG and NaPF₆ as the organic solid electrolyte between the electrode mixture and the inorganic solid electrolyte. However, the battery had a high resistance, with a discharging capacity of the active material at 10.1 mAh/g (0.42 mAh/cm²).

### Example 4

For the all-solid-state sodium storage battery of Example 4, the electrode mixture and the inorganic solid electrolyte were integrated by interposing the mixture consisting of PEG and NaPF₆ as the organic solid electrolyte between the electrode mixture and the inorganic solid electrolyte. The organic solid electrolyte was impregnated in the electrode mixture. As a result, the battery had a discharging capacity of the active material at 89.2 mAh/g (3.72 mAh/cm²).

### Example 5

For the all-solid-state sodium storage battery of Example 5, the electrode mixture and the inorganic solid electrolyte were integrated by interposing the mixture consisting of PEG and NaPF₆ as the organic solid electrolyte between the electrode mixture and the inorganic solid electrolyte. The organic solid electrolyte was impregnated in the electrode mixture. As a result, the battery had a discharging capacity of the active material at 92.6 mAh/g (3.86 mAh/cm²).

### Example 6

For the all-solid-state sodium storage battery of Example 6, the electrode mixture and the inorganic solid electrolyte were integrated by interposing the mixture consisting of PEG and NaPF₆ as the organic solid electrolyte between the electrode mixture and the inorganic solid electrolyte. The battery had a discharging capacity of the active material at 92.6 mAh/g (3.24 mAh/cm²).

### Reference Example 1

For the all-solid-state sodium storage battery of Reference Example 1, the electrode mixture and the inorganic solid electrolyte were not integrated since it did not comprise an organic solid electrolyte. In addition, the function of the battery was not at all achieved since it had a discharging capacity of the active material at 0.0 mAh/g (0 mAh/cm²). This means that the battery had a large resistance to ion flux in the interface between the electrode and the solid electrolyte even if a minute current was caused to flow at the rate of 0.01C.

### Reference Example 2

The liquid sodium ion battery of Reference Example 2 had a discharging capacity of the active material at 94.2 mAh/g (3.92 mAh/cm²).

### <Battery Overcharge Test>

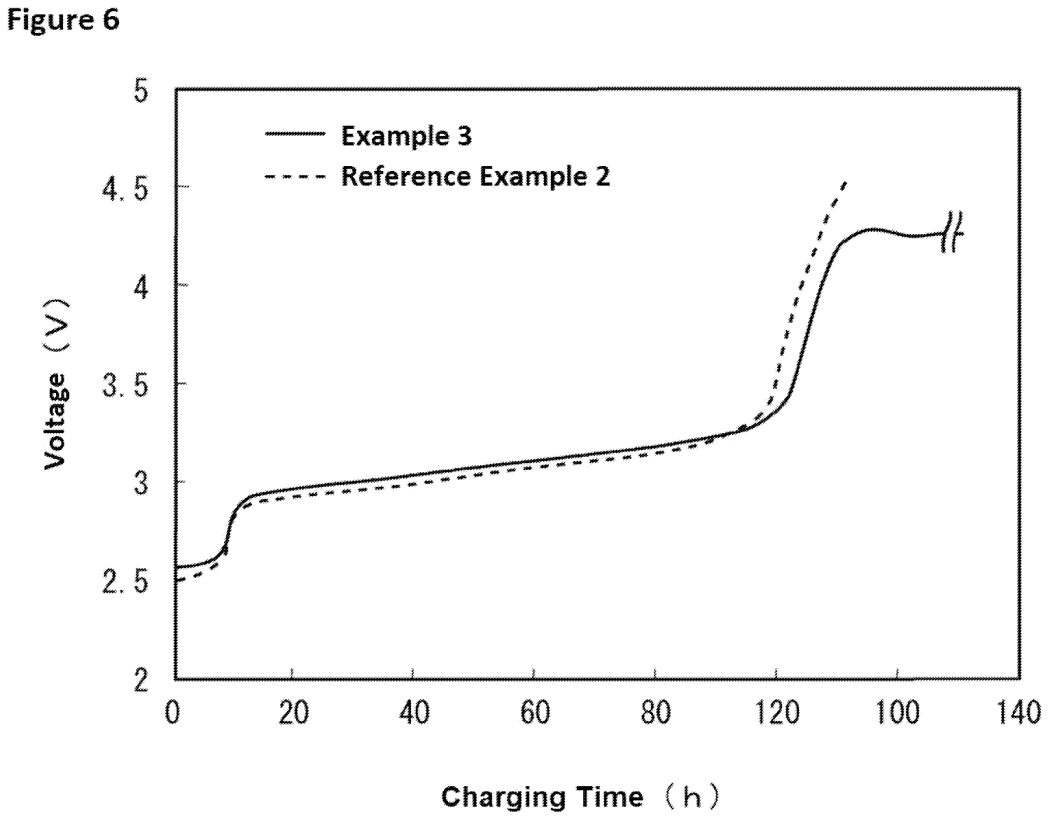

A battery overcharge test was conducted by constant-current charging at a temperature of 60° C., at a rate of 0.01C and at a charge cutoff voltage of 4.5V. FIG. 6 shows the comparison between the charge curves of Example 5 and Reference Example 2. The vertical axis indicates battery voltage, and the horizontal axis indicates charging time. When charged over 100 hours, the battery will be in the overcharge region. As apparent from FIG. 6, the battery of Example 5 was observed to have a charge plateau at around 4.2V, and it did not reach the charge cutoff voltage of 4.5V. In contrast, the battery of Reference Example 2 was not observed to have a charge plateau at around 4.2V, and it was charged until it reached the charge cutoff voltage. It is believed that the organic solid electrolyte interposed between the electrode mixture and the inorganic solid electrolyte was oxidatively decomposed at around 4.2V in the battery of Example 5. This result indicated that an organic solid electrolyte contained in a battery can suppress the overcharge.

The battery of Example 5 did not exhibit a discharging capacity when constant-current charged at a temperature of 60° C., at a rate of 0.01C and at a charge cutoff voltage of 4.5V until it reached an SOC (State of Charge) of 200%, followed by being constant-current discharged at a rate of 0.1C until it reached 2.0V. It is suggested that oxidative decomposition of the organic solid electrolyte caused an increase in battery resistance and thus a shutdown of the battery.

### INDUSTRIAL APPLICABILITY

The electrode mixture according to the present invention can be used as a component of an all-solid-state sodium storage battery. This all-solid-state sodium storage battery can maintain a higher discharging capacity in a room temperature environment as well as exhibit excellent charge-discharge cycle characteristics and has the ability to shut down when the battery is overcharged. Therefore, the battery is expected to be applied to power sources for EVs (electric vehicles) and stationary systems.

### EXPLANATIONS OF REFERENCES

1 Schematic sectional view of electrode mixture and all-solid-state sodium storage battery comprising the same
2 Electrode mixture
3 Organic solid electrolyte
4 Inorganic solid electrolyte
5 Counter electrode
6 Current collector
7 Schematic sectional view of active material cluster
8 Electrode active material particle
9 Polyphosphate acid transition metal oxide crystal
10 Electron conductive assistant (carbon)
11 Schematic sectional view of battery in bipolar configuration
12 Schematic of manufacturing process of all-solid-state sodium storage battery comprising electrode mixture according to the present invention
13 Roughened face

1. An electrode mixture used for an all-solid-state sodium storage battery, the electrode mixture comprising an active material,
wherein the active material is a cluster formed of polyphosphate acid transition metal oxide with a plurality of individual particles connected together, each particle having a particle size ranging from 0.1 μm to 100 μm.

2. The electrode mixture of claim 1, wherein the polyphosphate acid transition metal oxide is crystal represented by the general formula NaₐM_{b}P_{c}O_{d}, and
wherein M is at least any one selected from Fe, Mn, Co, Ni and V provided that 0.0<a≤3.5, b=1, 1.0≤c≤3.0, and 3.0≤d≤30.

3. The electrode mixture of claim 1, further comprising an ion conductive assistant, wherein the ion conductive assistant is at least one selected from a group consisting of ethylene carbonate (EC), polyethylene carbonate (PEC), polyethylene glycol (PEG), and polyethylene oxide (PEO).

4. The electrode mixture of claim 1, further comprising an electron conductive assistant, wherein the electron conductive assistant is at least one selected from a group consisting of metal, carbon material, conductive polymer, and conductive glass.

5. The electrode mixture of claim 4, wherein the electron conductive assistant is loaded on part or all of a surface of the electrode mixture.

6. The electrode mixture of claim 4, wherein the electron conductive assistant is loaded on a surface of a part that connects the individual particles of the active material.

7. The electrode mixture of claim 4, wherein the electron conductive assistant is contained within a part that connects the individual particles of the active material.

8. The electrode mixture of claim 4, wherein the electron conductive assistant is carbon selected from at least one of powdered carbon, fibrous carbon, and flaky carbon.

9. The electrode mixture of claim 8, wherein the carbon is powdered carbon having a primary particle size within the range of 1 nm to 100 nm.

10. The electrode mixture of claim 8, wherein the carbon is powdered carbon having a nitrogen adsorption specific surface area within the range of 20 m²/g to 500 m²/g.

11. The electrode mixture of claim 8, wherein the carbon is fibrous carbon having a fiber size within the range of 1 nm to 300 nm.

12. The electrode mixture of claim 8, wherein the carbon is flaky carbon having a thickness within the range of 1 nm to 300 nm.

13. The electrode mixture of claim 8, wherein the carbon is a combination of powdered carbon and fibrous carbon, or a combination of powdered carbon and flaky carbon, or a combination of powdered carbon, fibrous carbon and flaky carbon.

14. The electrode mixture of claim 1, wherein the electrode mixture does not comprise a resin binder.

15. The electrode mixture of claim 1, wherein the electrode mixture is porous comprising pores, and wherein the electrode mixture has a porosity within the range of 5% to 50%.

16. The electrode mixture of claim 15, wherein the pores have a pore size of 0.1 μm to 100 μm.

17. The electrode mixture of claim 1, comprising solid electrolyte powder having a particle size of 0.1 μm to 100 μm as an ion conductive assistant.

18. The electrode mixture of claim 15, wherein surfaces of the pores are covered with the solid electrolyte powder as an ion conductive assistant.

19. The electrode mixture of claim 1, wherein the electrode mixture has a thickness of 10 μm to 5000 μm and a total weight per unit area of 1 mg/cm² to 5000 mg/cm².

20. The electrode mixture of claim 1, wherein the electrode mixture is used as a positive electrode and/or a negative electrode in a non-aqueous electrolyte storage device, and wherein the non-aqueous electrolyte storage device is an all-solid-state sodium storage battery comprising the electrode mixture, an organic solid electrolyte, an inorganic solid electrolyte, and a current collector.

21. (canceled)

22. (canceled)
